(19) United States
(12) Patent Application Publication
(10) Pub. No.: US 2006/0181846 A1
(43) Pub. Date: Aug. 17, 2006

(54) Cooling system for a computer environment

(76) Inventors: Arthur K. Farnsworth, Houston, TX (US); Peter W. Austin, Spring, TX (US); Jeffrey A. Lambert, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/056,300

(22) Filed: Feb. 11, 2005

(51) Int. Cl. G06F 1/20

(52) U.S. Cl. 361/695; 361/687

(57) ABSTRACT

A cooling system comprises a first fan operable to push air to a device, where the air pushed forms an air column, a second fan adjacent to the device, and operable to pull air from the device, and a guide coupled to the first fan and the device and operable to guide the air column from the first fan to the second fan.

### BACKGROUND

Computer environments are known for having ever increasing thermal conditions. As processing speeds increase, and circuitry complexity and quantity increase, the heat generated in the confined space of a computer environment also typically increases. Generally, the circuitry and processors of a computer environment require a maximum level of heat tolerance above which the environment may become unpredictable. Thus, maintaining appropriate thermal conditions in a computer environment is an important objective in the design of computer systems. The challenges posed by this design objective arise for the most part by the characteristics of airflow in a computer chassis. One of those characteristics is the preheated air that circulates about a processor and its heatsink. Another characteristic is the reduced airflow velocity that occurs about the processor and its heatsink.

The above mentioned characteristics may yield unsatisfactory results in maintaining thermal conditions. For example, a processor generates a significant amount of heat that preheated air may not be able to dissipate effectively. Also, other circuits that typically generate a substantial amount of heat, such as voltage regulators, may not benefit from air circulation if the air pressure in the environment is not sufficient for the air to properly circulate about these other circuits. A technique that may be used to increase the air pressure is the use of power supply drafting. This technique, however, may not be effective in certain situations.

The abovementioned challenges may be overcome by putting more fans in the computer chassis and motherboard. In most designs, the main concern is to dissipate heat generated specifically by the main processor, and therefore the addition of fans focuses on air dissipation about the processor. However, this type of design may ignore heat generated by other circuits. Although fans may be added to address dissipation of heat specifically in other areas of the computer environment, such addition of fans also causes the noise factor within the computer environment to increase. This noise factor is another parameter that is taken into consideration for maintaining good quality, performance, and better user experience.

### SUMMARY

According to one embodiment, a cooling system comprises a first fan operable to push air to a device, where the air pushed forms an air column, a second fan adjacent to the device, and operable to pull air from the device, and a guide coupled to the first fan and the device and operable to guide the air column from the first fan to the second fan.

According to another embodiment, a method of generating an airflow comprises pushing air from the outside of a chassis to a device using a first fan, where the air pushed forms an air column, pulling air from the device using a second fan substantially parallel to the first fan and substantially aligned to receive at least a portion of the air column, and guiding the air column from the first fan to the second fan using a guide that is coupled to the bottom of the chassis.

According to yet another embodiment, a method for generating an airflow comprises setting performance criteria, controlling a first fan according to the performance criteria to push air from the outside of a chassis to a device, where the air pushed forms an air column, and controlling a second fan according to the performance criteria, adjacent to the device, and substantially aligned with the air column and operable to pull air from the device.

According to yet another embodiment, a cooling environment comprises a computer chassis comprising a bottom surface, at least two fans positioned in a series orientation, the at least two fans comprising a first fan operable to push air and rotating at a first speed and a second fan operable to pull air and rotating at a second speed, where the first speed is slower than the second speed, and an air guide comprising at least two openings and disposed between the at least two fans, where the at least two fans are substantially aligned with the at least two openings, the air guide being coupled to the bottom surface.

### BRIEF DESCRIPTION OF THE DRAWINGS

FIG. 1 is a block diagram of one embodiment of a cooling system;

FIG. 2 is an illustration of one embodiment of a computer environment including one embodiment of a cooling system;

FIG. 3 is an isometric view of an embodiment of cooling system;

FIG. 4 is a flowchart of one embodiment of a method for generating an airflow; and

FIG. 5 is a flowchart of another embodiment of a method for generating an airflow.

### DETAILED DESCRIPTION

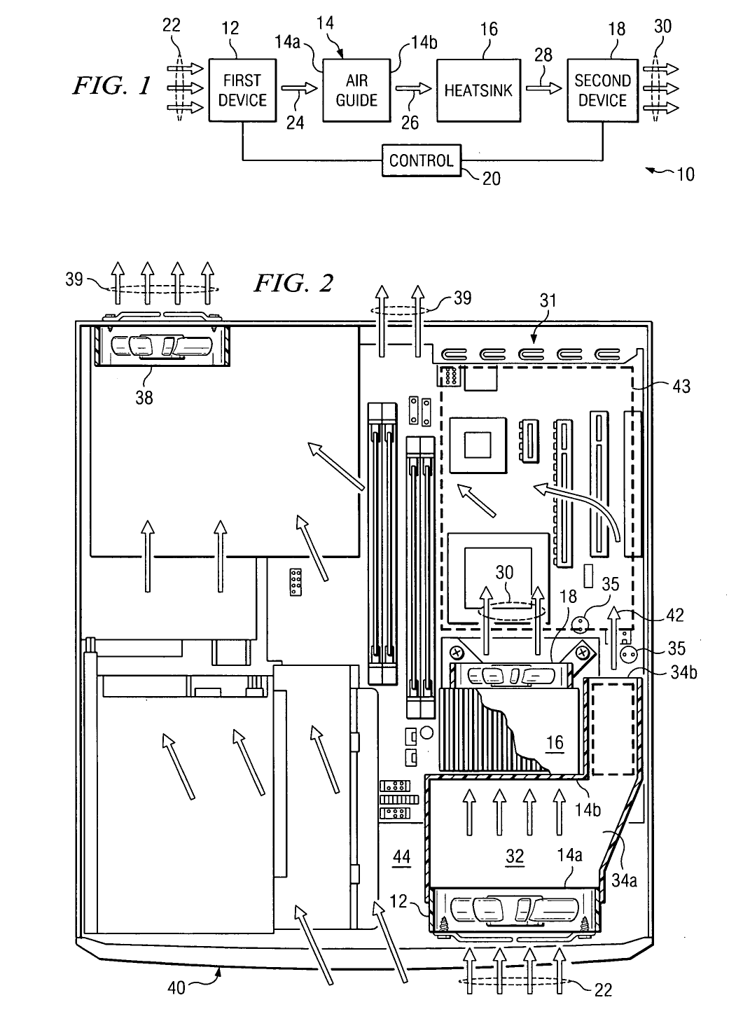

FIG. 1 is a block diagram of an embodiment of an airflow generating system 10 that may be used in a computer environment. Computer environments may be categorized by the dimensions of the environment, such as the length, width, and depth of a computer chassis, for example. With regards to dimensions, one embodiment may refer to a computer chassis as being a small form factor (SFF), which corresponds to a computer chassis having less than 300 cm². Although the term “computer chassis” is used to generally refer to a small form factor chassis, the teachings herein described apply to any chassis regardless of dimension.

System 10 comprises a first device 12, an air guide 14, a heatsink 16, a second device 18, and a control module 20 coupled as shown in FIG. 1. The first device 12 receives and pushes air 22 to the inside of a computer chassis. It is understood that the term “push” may be used to describe other airflow actions, such as drawing in air, for example. According to one embodiment, first device 12 is a system fan having dimensions 92 mm in length and 25 mm in width and operating at a speed of approximately between 1150 to 1500 revolutions per minute (rpm). Any other suitable device for pushing air to the inside of a computer chassis, such as a small form factor chassis, may be used. The pushed air 24 forms an air column that air guide 14 guides to heatsink 16. According to one embodiment, air guide 14 comprises an air duct formed in the circumferential shape of first device 12 at a first end 14a and formed to the circumferential shape of the heatsink 16 at the opposite end 14b in order to substantially guide pushed air 24 to heatsink 16.

Heatsink 16 is generally coupled to a semiconductor device, such as a processor, to conduct heat away from the device and radiate the heat to the computer environment. According to one embodiment, heatsink 16 is substantially aligned with the opposite end 14b of air guide 14 in order to receive a substantial portion of air column 26. Air column 26 may include a substantial portion of the pushed air 24. According to another embodiment, air column 26 is partitioned to direct a portion of air column 26 to at least one semiconductor device other than that device coupled to heatsink 16. A partitioned air guide will be more particularly described with reference to FIG. 2.

Second device 18 pulls air from heatsink 16 and the adjacent environment. According to this embodiment, second device 18 is a device fan that pulls heated air 28 and dissipates heated air 28 into the environment as dissipated air 30. In one embodiment, second device 18 is a device fan having dimensions of 70 mm in length and 15 mm in width and operating at a speed of approximately between 2300 and 3200 rpm. Second device 18 of the illustrated embodiment is substantially aligned with heatsink 16 and the opposite end 14b of air guide 14. First device 12 and second device 18 of one embodiment are both axial fans that are adapted for use in a computer chassis in what is called a “series” orientation. That is, the fans may be oriented such that the center of rotation of each fan is in series with each other. This description, however, should in no way limit the dimension, efficiency, operation, and placement of first device 12 and second device 18. As long as first device 12 and second device 18 are substantially aligned with respective portions of air guide 14, their location in the chassis and their dimension, by way of example, should not be limited.

Control module 20 comprises software and/or hardware suitable for controlling first device 12 and second device 18. According to one embodiment, control module 20 is program code residing in the Basic Input Output System (BIOS) of a computer embodied in the computer chassis in such a way that first device 12 and second device 18 may be controlled through various settings. These settings may be predetermined according to certain criteria that are set to maintain the appropriate thermal conditions of the computer environment, or individual components within the computer environment. Other criteria may be selected, such as noise level, air pressure, fan efficiency, speed of operation, fan curves, for example. Controlling first device 12 and second device 18 at least in part by software facilitates dynamic adjustments of fan controls and independent operation of each device 12 and 18. According to another embodiment, control module 20 comprises circuitry that controls first device 12 and second device 18 via electrical signals. Any other suitable control mechanism or method may be used to control first device 12 and second device 18.

In summary, system 10 includes a control module 20 that controls first device 12 and second device 18 to maintain thermal and noise conditions in the computer environment, among other criteria. First device 12 pushes air 22 into a computer chassis forming an air column 24, which is directed or guided by air guide 14. Air guide 14 is substantially aligned with first device 12 and heatsink 16 to direct a substantial portion of air column 24 to heatsink 16 to dissipate heat generated by the device coupled to heatsink 16. Second device 18 is substantially aligned with and pulls air from heatsink 16 to generate dissipated air 30, which may be circulated out of the computer chassis through orifices in the chassis. According to one embodiment, first device 12 and heatsink 6 are coupled to air guide 14 at ends 14a and 14b, respectively.

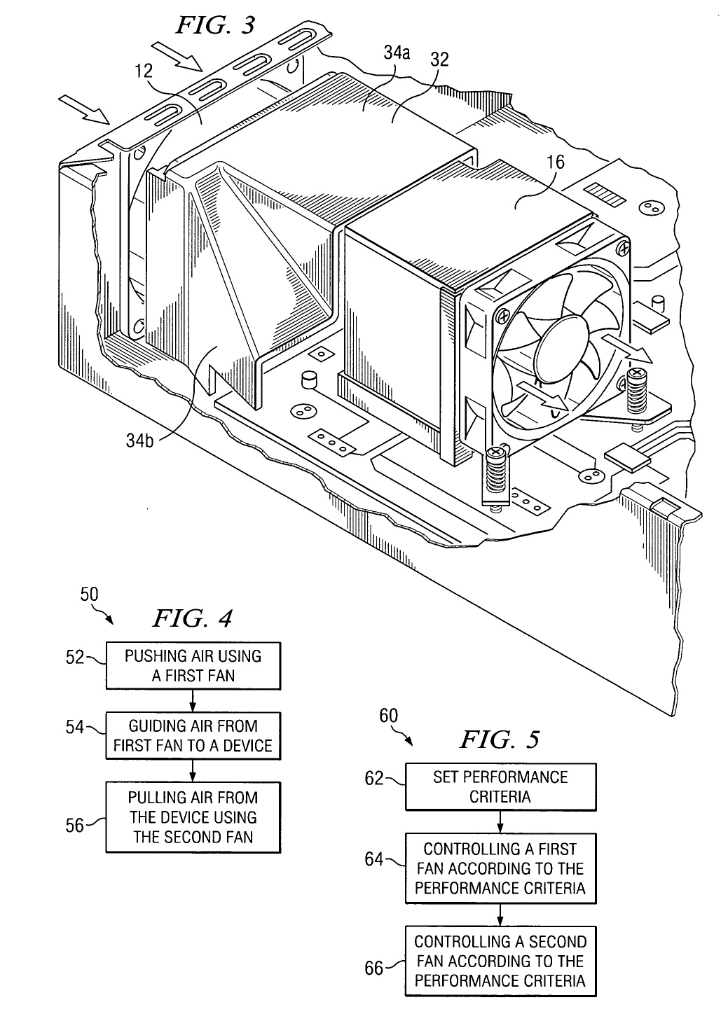

From the above description, an advantage of system 10 that is apparent is that air guide 14 ensures that air circulation in the computer chassis is not substantially compromised by adding or removing devices or by opening the computer chassis. Usually, when the computer chassis is opened and the computer is allowed to remain “on,” the air pressure that may have resulted from the closed environment is compromised. System 10 allows the user of the computer to operate the computer while the computer chassis is open without substantially compromising air column 24. According to another embodiment, a power supply fan facilitates the generation of dissipated air 30 that is circulated about other circuits in the computer chassis before being drafted out of the computer chassis. This additional circulation may enhance the air circulation in areas not traditionally benefiting from airflow. In one embodiment, such area may be the corner areas. A device that benefits from the enhanced circulation may be, in one example, the Peripheral Component Interconnect (PCI) graphics card area, which may be located in some computer designs in a corner area. Such embodiment will be more particularly described with reference to FIG. 3.

FIG. 2 is an illustration of another embodiment of a cooling system 10 having a partitioned duct 32 in a computer environment 31. According to the illustrated embodiment, partitioned duct 32 is substantially aligned with first device 12 to form an air column that is partitioned to direct air to specific areas of the motherboard. For example, partitioned duct 32 comprises a main portion 34a and a partitioned portion 34b, where main portion 34a guides air to heatsink 16, while partitioned portion 34b guides partitioned air 42 to circuits 35. Circuits 35 may be any suitable heat generating circuit, such as a voltage regulator. Any other circuit device or circuits may be placed in the vicinity of the partition of portioned duct 32 to receive directed air circulation. One advantage of the partitioned duct 32 is that, in addition to providing directed air circulation, the air pressure of the airflow is increased without increasing fan speed, which in turn facilitates keeping the noise level at a certain noise level condition in the environment. The increased air pressure also increases the dissipation of the preheated air being dissipated by heatsink 16 and pulled by second device 18. Additionally, in an ever shrinking computer environment, air circulation is improved without having to sacrifice significant space on the circuit boards located on the motherboard.

According to the illustrated embodiment, partitioned duct 32 is made out of plastic and it attaches to first device 12, heatsink 16, and the bottom surface 44 of the computer chassis. In the illustrated embodiment, bottom surface 44 is the motherboard surface. Other surfaces may be used as bottom surface 44 without limitation. The partition of partitioned duct 32 may also be sloped, or angled downward, to create more air pressure and air circulation to be directed in the direction desired. As was previously described, the direction of the partitioned air 42 may target heat generating circuits, such, for example, as a voltage regulator circuit. In other embodiments, partitioned duct 32 may comprise more than one partition.

According to the illustrated embodiment, first device 12 is a system fan that is located adjacent to the front panel 40 of a computer chassis and is mounted vertically from the bottom surface 44 of the chassis. This location may result in first device 12 operating at a lower speed than second device 18 so that a certain noise level condition is not exceeded. This noise level condition is, in certain circumstances, arrived at by performing acoustic performance tests that describe the level of noise that a computer user would perceive acceptable. Although the first device 12 has been described in this embodiment as being located adjacent to front panel 40, first device 12 may be located anywhere else on the chassis area. Additionally, first device 12 may operate at any other suitable speed, for example, first device 12 may operate at the same speed than second device 18 without departing from the scope of the invention.

According to the illustrated embodiment, a third device 38 may be used to circulate partitioned air 42 and dissipated air 30 out of the chassis as output air 39. The chassis may have orifices in various areas of the back and side panels that may facilitate further output of partitioned air 42 and dissipated air 30 outside of the computer chassis. In this embodiment, third device 38 comprises a power supply fan that is configured to perform power supply drafting. Third device 38 may be suitably located anywhere in the computer chassis without limitation.

Environment 31 includes control module 20, which was described with respect to FIG. 1, in the form of a combination of processor and software, where the software resides in the BIOS of the computer. The software may be embodied in any other suitable medium, such as, for example, Random Access Memory (RAM), Read-Only Memory (ROM), hard disk drives, floppy drive media, optical media, or any other suitable computer storage, whether removable or not. According to one embodiment, the software includes fan curve data and associated instructions that the processor executes to dynamically, and independently change the speed and operation of first device 12 and second device 18. The fan curve data may be adjusted and selected to maintain thermal conditions, noise levels, and any other suitable criteria.

The abovementioned adjustments provide advantages that result in a cooling system 10 that may be adapted to different computer environments 31. For example, in one environment 31, a certain set of devices may require a specific operation of the fans to maintain the corresponding thermal condition, while at another environment 31 the same system 10 may be adapted to operate with the fans at different speeds or operation if the thermal conditions vary. Such variance of thermal conditions may result from the addition or removal of devices and/or circuits that have an associated thermal release. According to the illustrated embodiment, cooling system 10 is operable to dissipate approximately between 90 to 100 Watts of heat at the processor an operating ambient temperature of 35° Celsius. At a maximum, system 10 dissipates approximately 115 Watts of heat at the processor at the same ambient temperature.

An advantage that results from the increase of static pressure and improved air circulation is that the PCI graphics card area 43 may receive directed airflow. In the present embodiment, second device 18 located on the back of heatsink 16 pulls preheated air having increased air pressure which may increase the velocity of airflow received by PCI graphics card area 43, which may be referred to as a downstream device because of its location with reference to the airflow stream. Any other downstream device may receive the benefits of improved air circulation resulting from the use of system 10.

The present embodiment may be modified where additions and omissions may be made without limitation. For example, although air guide 32 has been described as a duct, any other enclosure suitable for guiding air column 24 from first device 12 to heatsink 16 or second device 18 may be used. As another example, partitioned portion 34a of air guide 32 may be modified to be shortened, lengthened, widened, or narrowed without limitation, or it may be removed from air guide 32.

FIG. 3 is an isometric view of an embodiment of cooling system 10. As may be perceived from this embodiment, air guide 32 may be shaped in any suitable shape and may be of any suitable dimension. It will also be understood that air guide 32 may be coupled to the motherboard of the computer, the bottom surface 44, illustrated in FIG. 3, of the computer chassis or any other suitable devices. In the present embodiment, air guide 32 is coupled to first device 12 and includes a partitioned portion 34b that is slanted downward and having an air circulation area smaller than the main portion 34a of air guide 32.

FIG. 4 and referring to FIGS. 1, 2, and 3 is a flowchart of one embodiment of a method 50 for generating airflow. The method begins at operational block 52, where a first fan pushes air from the outside of a chassis to a device. The first fan is vertically positioned with respect to the bottom surface 44 of a computer chassis, as the illustrated in FIGS. 2 and 3. According to embodiments, the bottom surface 44 of the chassis is the horizontal plane that forms the base of the chassis and is the plane where a motherboard of a computer would normally be laid out. Pushing air at this stage initiates the formation of an air column 24.

A second fan pulls air from a device, such as a semiconductor device having a heatsink 16, where the second fan 18 is located parallel to the first fan 12 and is substantially aligned to receive at least a portion of the air column 24, at operational block 56. As was explained earlier, the fans may be positioned in a series orientation, such that the axis of rotation is in series. This orientation also places the plane on which the fans are laid out perpendicular to each other. In other embodiments, the fans are laid out vertically positioned with the air column 24 substantially aligned with the axis of rotation of the fans 12, 18, such as if duct 32 is bent shaped, the planes of the fans do not have to be perpendicular to each other. The second fan is operable to pull air from a semiconductor device, such as a processor or other circuits that may not necessarily be associated with a heatsink. At step 54, air guide 32 guides a substantial portion of air column 24 from first device 12 to second device 18. In some embodiments, air guide 32 comprises a partitioned portion 34b that directs a partitioned portion 42 of air column 24 to other circuits located in areas adjacent to heatsink 16. It is understood that steps may be performed in any order, without limitation. For example, pushing air using a first fan at step 52 and guiding air from the first fan 12 to a device at step 54 may be performed substantially simultaneously.

FIG. 5 is a flowchart of another embodiment of a method 60 for generating airflow. The method begins at operational block 62, where performance criteria are set. In one embodiment, performance criteria are parameters such as thermal condition levels, noise levels, and other suitable performance parameters that may be set for a particular computer environment 31. For example, in the embodiments concerning a small form factor chassis, a certain noise level may be set for the environment 31, which level was obtained using, for example, an acoustic test that measures system idle conditions, which may yield a noise level of a maximum of 28 dbA. As was already explained with respect to another embodiment, the thermal condition may be set to a range between 90 and 100 Watts of heat dissipation at the processor, which may be the thermal condition range of a small form factor chassis having certain heat producing devices. It is understood that as devices are added, changed, or improved, the thermal conditions of computer environment 31 may also change and therefore the performance criteria may also change. It is also understood that while performance criteria has been specified for a small form factor chassis, the performance criteria may be also applicable to chassis of different dimensions.

At operational block 64, control module 20 controls a first fan according to the performance criteria, where the first fan is a system fan that is configured to push air from the outside of the computer chassis to a heatsink 16. Control module 20 controls a second fan according to the performance criteria at operational block 66. It is understood that steps may be performed in any order, without limitation. For example, controlling first device 12 according to the performance criteria at operational block 64 and controlling second device 18 according to the performance criteria at step 66 may be performed substantially simultaneously.

Although an embodiment of the invention and its advantages are described in detail, a person skilled in the art could make various alterations, additions, and omissions without departing from the spirit and scope of the present invention as defined by the appended claims.

What is claimed is:

1. A cooling system comprising:
a first fan operable to push air to a device, where the air pushed forms an air column;
a second fan adjacent to the device, and operable to pull air from the device; and
a guide coupled to the first fan and the device and operable to guide the air column from the first fan to the second fan.

2. The cooling system of claim 1 further comprising a third fan positioned in the chassis and operable to receive at least a portion of the air pulled from the device and to circulate the air outward from the chassis.

3. The cooling system of claim 1, wherein the first fan comprises a system fan, and where the system fan is located in the front panel of a small form factor chassis.

4. The cooling system of claim 1, wherein the device comprises a heatsink and the second fan comprises a heatsink fan.

5. The cooling system of claim 1 wherein the guide comprises an air duct coupled to the first fan and the device, the air duct operable to substantially align at least part of the air column between the first fan and the second fan.

6. The cooling system of claim 5, wherein the air duct further comprises at least one partition operable to direct at least a portion of the air column toward a second device located inside the chassis.

7. The cooling system of claim 1, wherein the first device operates at a first speed and the second device operates at a second speed, where the first speed is lower than the second speed.

8. The cooling system of claim 7, wherein the first speed comprises a speed in the range of approximately between 1150 and 1500 revolutions per minute, and wherein the second speed comprises a speed in the range of approximately between 2300 and 3200 revolutions per minute.

9. A method of generating an airflow comprising:
pushing air from the outside of a chassis to a device using a first fan, where the air pushed forms an air column;
pulling air from the device using a second fan substantially parallel to the first fan and substantially aligned to receive at least a portion of the air column; and
guiding the air column from the first fan to the second fan using a guide that is coupled to the bottom of the chassis.

10. The method of claim 9 further comprising extracting at least a portion of the air pulled from the device outward from the chassis using a third fan positioned in the chassis.

11. The method of claim 9 wherein:
pushing air from the outside of the chassis to the device further comprises rotating the first fan at a first speed; and
pulling air from the device further comprises running the second fan at a second speed, wherein the first speed is lower than the second speed.

12. The method of claim 9 wherein guiding the air column from the first fan to the second fan further comprises coupling an air duct to the first fan and the device.

13. The method of claim 9 further comprising substantially aligning at least part of the air column between the first fan and the second fan using an air duct.

14. The method of claim 9 further comprising partitioning the air column to direct at least a portion of the air column toward a second device located in the chassis.

15. The method of claim 11, further comprising controlling the first speed and the second speed, where the first speed comprises a speed in the range of approximately between 1150 and 1500 revolutions per minute, and wherein the second speed comprises a speed in the range of approximately between 2300 and 3200 revolutions per minute.

16. A method for generating an airflow comprising:
setting performance criteria;
controlling a first fan according to the performance criteria to push air from the outside of a chassis to a device, where the air pushed forms an air column; and
controlling a second fan according to the performance criteria, adjacent to the device, and substantially aligned with the air column and operable to pull air from the device.

17. The method of claim 16 further comprising controlling a third fan positioned in the chassis and operable to receive at least a portion of the air pulled from the device and to circulate the air outward from the chassis.

18. The method of claim 16 further comprising independently adjusting:
a first speed associated with the first fan; and
a second speed associated with the second fan.

19. The method of claim 18, wherein the first speed is slower than the second speed.

20. The method of claim 16, wherein the performance criteria comprises a member of a group consisting of noise level, heat level, rotation speed, response time, and efficiency.

21. The method of claim 16, wherein:
controlling a first fan according to the performance criteria further comprises determining a first speed using fan curve data associated with the first fan; and
controlling a second fan according to the performance criteria further comprises determining a second speed using fan curve data associated with the second fan.

22. A cooling environment comprising:
a computer chassis comprising a bottom surface;
at least two fans positioned in a series orientation, the at least two fans comprising a first fan operable to push air and rotating at a first speed and a second fan operable to pull air and rotating at a second speed, where the first speed is slower than the second speed; and
an air guide comprising at least two openings and disposed between the at least two fans, where the at least two fans are substantially aligned with the at least two openings, the air guide being coupled to the bottom surface.

23. The cooling environment of claim 22, wherein the air guide comprises at least one partition.

24. The cooling environment of claim 22, wherein the air guide comprises a partitioned portion and a main portion, where the main portion is operable to guide pushed air to a heatsink, and the where the partitioned portion is operable to guide pushed air to at least one circuit.

25. A cooling apparatus comprising:
means for setting performance criteria;
means for controlling a first fan according to the performance criteria to push air from the outside of a chassis to a device, where the air pushed forms an air column; and
means for controlling a second fan according to the performance criteria, adjacent to the device, and substantially aligned with the air column and operable to pull air from the device.

26. The cooling apparatus of claim 25 further comprising means for controlling a third fan positioned in the chassis, the third fan operable to receive at least a portion of the air pulled from the device and to circulate the air outward from the chassis.

27. The cooling apparatus of claim 25 further comprising means for independently adjusting:
a first speed associated with the first fan; and
a second speed associated with the second fan.

28. The cooling apparatus of claim 27, wherein the first speed is slower than the second speed.

29. The cooling apparatus of claim 25, wherein the performance criteria comprises a member of a group consisting of noise level, heat level, rotation speed, response time, and efficiency.
